(19) United States
(12) Patent Application Publication
(10) Pub. No.: US 2018/0279444 A1
(43) Pub. Date: Sep. 27, 2018

(54) METHOD OF MANUFACTURING ELECTROLUMINESCENT DEVICE AND ELECTROLUMINESCENT DEVICE

(71) Applicant: TAICA CORPORATION, Tokyo (JP)

(72) Inventor: PAUL RYE, FARMINGTON HILLS, MI (US)

(21) Appl. No.: 15/469,936

(22) Filed: Mar. 27, 2017

(51) Int. Cl. H05B 33/10; H05B 33/22; H05B 33/28; H05B 33/14; B05D 1/02; B05D 7/00

(52) U.S. Cl. CPC H05B 33/10; H05B 33/22; B05D 7/58; H05B 33/145; B05D 1/02; H05B 33/28

(57) ABSTRACT

[Problem] There is provided a method of manufacturing an electroluminescence (EL) device which can apply a pattern to a base substance having a curved surface with high productivity.

[Solution means]

There are included a step (A) of selecting a substrate; a step (B) of applying a base backplane film layer upon said substrate; a step (C) of applying a dielectric film layer upon said backplane film layer; a step (D) of applying a phosphor film layer upon said dielectric film layer; and a step (E) of applying a transparent electrode film layer upon said phosphor film layer, wherein said backplane film layer, said dielectric film layer, said phosphor film layer and said transparent electrode film layer each are applied by spray coating; and further comprising the step of (F) forming a decorative pattern layer by water pressure transfer method on at least one portion between said phosphor layer formed by the step (D) and said electric film layer formed by the step (E).

### DETAILED EXPLANATION OF THE INVENTION

### Technical Field

This invention relates to a method of manufacturing an electroluminescence device having a lower electrode layer to be connectable to an electric drive circuit and an upper electrode film layer and an electroluminescence device manufactured by this method, and more particularly to a method of manufacturing an electroluminescence device (EL device) having at least one phosphor film layer in order to form at least one electroluminescence area between the upper and lower electrode layers and an electroluminescence device (EL device) manufactured by this method.

### Background Art

There is disclosed in Patent Document No. 1 (JP2015-503829A), Patent Document No. 2 (WO2013/102859) and Patent Document No. 3 (U.S. Pat. No. 8,470,388 specification) (Patent Document Nos. 1 through 3 are a patent family) a method of manufacturing an electroluminescence device (EL device) suitably applied to articles having a complicated surface shape for such as an electroluminescence device (EL device).

In these documents is described a problem and means to solve the problem stated below.

Firstly, according to the problem described in these documents, since the 1980s, electroluminescent (EL) technology has come into widespread use in display devices where its relatively low power consumption, relative brightness and ability to be formed in relatively thin film configurations have shown it to be preferable to light emitting diodes (LEDs) and incandescent technologies for many applications.

Commercially manufactured EL devices have traditionally been manufactured using doctor blade coating and printing processes such as screen printing or, more recently, ink jet printing. For applications that require relatively planar EL devices these processes have worked reasonably well, as they lend themselves to high-volume production with relatively efficient and reliable quality control.

However, traditional processes are inherently self-limiting for applications where it is desirable to apply an EL device to a surface having complex topologies, such as convex, concave and reflexed surfaces. Partial solutions have been developed wherein a relatively thin-film EL “decal” is applied to a surface, the decal being subsequently encapsulated within a polymer matrix. While moderately successful, this type of solution has several inherent weaknesses. Firstly, while decals can acceptably conform to mild concave/convex topologies, they are incapable of conforming to tight-radius curves without stretching or wrinkling. In addition, the decal itself does not form either a chemical or mechanical bond with an encapsulating polymer, essentially remaining a foreign object embedded within the encapsulating matrix. These weaknesses pose difficulties in both manufacturing and product life-cycle, as embedded-decal EL lamps applied to complex topologies are difficult to manufacture and are susceptible to delamination due to mechanical stresses, thermal stresses and long-term exposure to ultraviolet (UV) light. There remains a need for a way to manufacture an EL lamp that is compatible with items having a surface incorporating complex topologies.

The Patent Document Nos. 1 to 3 have proposed a method of manufacturing the EL device by spray conformal coating to a base substance having a curve surface in order to solve this problem. Moreover, there has been practically used a decorative article on which is applied arbitrary patterns to the uppermost surface of the EL device manufactured by this method whereby the patterns are visually exposed by the luminescence from the EL device for parts of automobile cars, for example.

### PRIOR ART DOCUMENT

### Patent Documents

[Patent document No. 1] JP2015-503829A

[Patent document No. 2] WO 2013/102859

[Patent document No. 3] U.S. Pat. No. 8,470,388 specification

### SUMMARY OF THE INVENTION

### Problem to be Solved by the Invention

In manufacturing the EL device having such patterns applied as aforementioned, the patterns are usually depicted by an air brush, which is poor in mass production or reproduction and has the lower workability because a masking operation is required. In case where the EL device is decorated by in-mold transfer or three-dimensional overlay method also referred to as TOM formation using a thermoplastic decoration film having a pattern formed, the EL device might be damaged by stress accompanying formation of the decorative pattern layer during or after the decoration operation of the EL device.

On the other hand, it will be considered to apply a pattern on the transparent electrode layer which is the uppermost layer of the EL device by a water pressure transfer method. When applying the pattern on the transparent electrode layer by the water pressure transfer, a pretreatment for removing a foreign substance such as deposit on the surface of the transparent electrode layer will be often required in order to improve the process yield and this pretreatment is performed by polishing the surface of the transparent electrode layer so as to correct the surface thereof. However, the correction process such as the polishing of the surface of the transparent electrode layer possibly causes a change in the electrical property of the transparent electrode layer. Accordingly, in preparation for the situation where the surface correction process is needed, a transparent base coat layer might be laminated on the transparent electrode layer and the correction process such as the polishing of the base coat might be performed. As a result, since the process of forming the base coat layer is added, there will be disadvantageously poor in the mass production.

Accordingly, one of the problems of the invention is to provide a method of manufacturing an electroluminescence (EL) device in which a pattern can be applied to a base substance having a curved surface with high productivity and visibility in order to eliminate the aforementioned problems of the prior art.

Another problem of the invention is to provide an electroluminescence (EL) device with electroluminescence (EL) functional layers having patterns applied therein and laminated onto a base substrate having a curved surface.

### Means to Solve the Problems

In order to solve one of the aforementioned problems, first problem solution means of the invention is to provide a method of manufacturing an electroluminescence device, said method comprising the following steps of

(A) selecting a substrate;
(B) applying a backplane film layer upon the substrate;
(C) applying a dielectric film layer upon said backplane film layer;
(D) applying a phosphor film layer upon said dielectric film layer; and
(E) applying a transparent electrode film layer upon said phosphor film layer,
wherein said backplane film layer, said dielectric film layer, said phosphor film layer and said transparent electrode film layer each being applied by spray coating;
said method characterized by further comprising the step of (F) forming a decorative pattern layer by a water pressure transfer method on at least one portion between said phosphor layer formed by the step (D) and said electric film layer formed by the step (E).

Second problem solution means of the invention is to provide a method of manufacturing an electroluminescence device, comprising the following steps of:

(A) selecting a substrate, at least one portion of which is visually transparent;
(B) applying a first electrode film layer of transparent electrically conductive material upon said substrate;
(C1) applying a first phosphor film layer upon said first electrode film layer;
(D) applying a dielectric film layer upon said first phosphor layer; and
(C2) applying a second phosphor film layer upon said dielectric film layer; and
(E) applying a second electrode film layer upon said second phosphor film layer;
wherein said first electrode film layer, said first phosphor film layer, said dielectric film layer, said second phosphor film layer and said second electrode film layer are formed by spray coating,
said method characterized by further comprising the step of (F) forming a decorative pattern layer by a water pressure transfer method on at least one portion between said substrate selected by the step (A) and said first electrode film layer formed by the step (B) and/or between said second phosphor film layer formed by the step (C2) and said second electrode film layer formed by the step (E).

Third problem solution means of the invention is to provide a method of manufacturing an electroluminescence device according to the first or second problem solution means, and further comprising two or more electroluminescence device components each formed using the steps of the first or second problem solution means.

Fourth problem solution means of the invention is to provide an electroluminescence device formed by either of said first through third problem solution means

### The Effect of the Invention

According to the present invention, since the EL layers are formed by spray coating in the same manner as disclosed in the Patent Document Nos 1 through 3, the EL layers can be easily formed upon a substrate having a complicated surface shape thereof and since the patterns are formed inside the EL layers by water pressure transfer, the method of the invention has excellent workability and mass production, in comparison with the case where they are formed by the conventional air brush and has no damage of the EL layers as manufactured in the conventional case where the patterns are formed by the in-mold transfer or the TOM molding. In addition thereto, since the decorative pattern layer is formed not on the transparent electrode layer impossible to be corrected, but on the phosphor film layer or the substrate possible to be corrected, there is required no base coating when carrying out the water pressure transfer of the decorative pattern layer, which improves the mass production. Furthermore, since the phosphor film layer functions as the base coat layer when the decorative pattern layer is applied on the phosphor film layer, the visibility of the pattern is improved.

### BRIEF DESCRIPTION OF THE DRAWINGS

FIG. 1 is a schematic diagram of an electroluminescence device according to the first mode of embodiment of the invention;

FIG. 2 is a schematic diagram of an electroluminescence device according to the second mode of embodiment of the invention;

FIG. 3 is a schematic diagram of an electroluminescence device according to the third mode of embodiment of the invention;

FIG. 4 is a schematic diagram of water pressure transfer of a pattern used for all the modes of embodiment of the invention.

### MODE OF EMBODYING THE INVENTION

A method of manufacturing an electroluminescence device (EL device) according to some modes of embodiment of the invention will be described below.

### First Mode of Embodiment

A basic principle of a method of manufacturing an EL device of the invention is to comprise a substrate, upper and lower electrode layers, at least one dielectric film layer and phosphor film layer arranged between the upper and lower electrode layers, which constitute the EL device, wherein the electrode layers, the dielectric film layer and the phosphor film layer are formed by spray coating so as to follow a non-flat surface such as surface unevenness of the substrate while a decorative pattern layer is formed between them by water pressure transfer so as to be visible from the surface.

Describing the method of manufacturing the EL device 10 by the fundamental mode of embodiment of the invention (the first embodiment) will be described in detail with reference to FIG. 1, the method illustrated in FIG. 1 comprising the steps of

(A) selecting a substrate 12;
(B) applying an electric conductive base backplane film layer (lower electrode layer) 16 upon the substrate 12 selected in the step (A);
(C) applying a dielectric film layer 18 upon the electric conductive backplane film layer 16 formed in the step (B);
(D) applying a phosphor film layer 20 upon the dielectric film layer 18 formed in the step (C);
(E) applying a transparent electrode film layer (upper electrode layer) 24 upon the phosphor film layer 20, and
(F) forming a decorative pattern layer 22 on at least portion between the phosphor film layer 20 formed in the step (D) and the transparent electrode film layer 24 formed in the step (E)
wherein the backplane film layer 16 of the step (B), the dielectric film layer 18 of the step (C), the phosphor film layer 20 of the step (D) and the transparent electrode film layer 24 of the step (E) are applied by spray coating while the decorative pattern layer 22 of the step (F) is formed by a water pressure transfer method.

In the first mode of embodiment of FIG. 1, a bus bar 28 may be formed adjacent to the electrode film layer 24 and a transparent topcoat layer 30 may be formed on the electrode film layer 24. The bus bar 28 and the topcoat layer 30 may be formed by coating using an airbrush or a gravity supply type spray.

In the mode of embodiment of FIG. 1, a primer layer 14 may be formed between the substrate 12 and the electrically conductive backplane film layer 16 and the primer layer 14 is also formed by the spray coating. The function of the primer layer 14 will be described later.

### (Substrate)

Typically, the substrate 12 may be a surface of an article on which the EL device is mounted and although the material of the substrate material particularly is not limited, it may be resin material.

### (Primer Layer)

In case where the primer layer 14 may be formed between the substrate 12 and the backplane electrode layer 16, the primer layer 14 may be in the form of an electrically non-conductive coat layer and this primer layer 14 functions to electrically insulate the electrically conductive backplane electrode layer 16 provided thereon from the substrate 12 and furthermore to improve the adhesion between the substrate 12 and the backplane electrode layer 16.

### (Backplane Electrode Layer)

Although the electrically conductive backplane electrode layer 16 may be formed by coating spray-possible backplane material, the backplane material may be adjusted so as to conform to various environment and uses. In one form, the backplane electrode layer 16 may be formed of electrically high conductive and opacity material. An example of such material may be a solution containing much silver of alcohol/latex base such as SILVASSPRAY (trademark) manufactured by Caswell, Inc. of Lyons, N.Y. or a solution containing much latex-like copper in an aqua basis such as “Caswell Copper”, an electrically conductive paint manufactured by Caswell, Inc.

The conductive backplane electrode layer 16 may be an electrically conductive metal plating layer applied via the primer layer 14 to the substrate 12. The metal plating layer referred to herein may include an electroless metal plating layer, a vacuum metal film, a vapor deposition layer and a sputtering layer. In case where the backplane electrode layer 16 is formed of the plated material, the resistance of the backplane electrode layer 16 may be desirably less than about 1 ohm/cm².

The conductive backplane electrode layer 16 may be of transparent material in place of the aforementioned opaque material. An example of the transparent material may be an electrically material such as an electrically conductive polymer of “CLEVIOS (trademark) SV3” or “CLEVIOS (trademark) SV4” of Heraeus Clevious GmbH of Leverkusen in Germany.

### (Dielectric Film Layer)

The dielectric film layer 18 may be formed of electrically non-conductive material having comparatively higher dielectric constant and enclosed in an insulating polymer matrix having a comparatively higher dielectric constant, typically barium titanate BaTiO₃. In one example, the dielectric film layer 18 may be a solution containing a copolymer and dilution ammonium hydroxide with a ratio of about 2:1. Some BaTiO₃ prewetted with ammonium hydroxide may be added to the solution to form over-saturation suspension. In another example, the dielectric film layer 18 may contain at least one of a titanate, an oxide, a niobate, an aluminate, a tantalate and a zirconate.

The dielectric film layer 18 functions as a source of supply of electric charge for illuminating the phosphor film layer 20. More concretely, when an AC signal 30 is applied between the backplane electrode layer 16 and the upper electrode film layer 24, the dielectric film layer 18 generates an electric charge on an interface with the phosphor film layer 20 due to the electromagnetic peculiar polarization characteristic which the material of the dielectric film layer 18 itself has and the electric charge is accelerated in an AC electric field and collides with the fluorescence material distributed in the phosphor film layer 20, which causes the fluorescence material to be excited to manufacture luminescence when it is relaxed to a ground state. The dielectric constant of the dielectric film layer 18 is desirably larger than the dielectric constant of the phosphor film layer 20 as much as possible in order to improve the luminous efficiency of the phosphor film layer 20. Since the dielectric film layer 18 has high withstand voltage, it functions as an insulation barrier between the backplane electrode layer 16 and the half-conductive phosphor film layer 20 and between the backplane electrode layer 16 and the upper electrode film layer 24 or its bus bar 28 and has a function to stably apply high electric filed to the phosphor film layer 20. Furthermore, the dielectric film layer 18 is much penetrable to the electrostatic field generated between the backplane electrode layer 16 and the upper electrode film layer 24.

Furthermore, in a multilayer EL device, there may be used the dielectric film layer 18 of photorefraction characteristic influencing the refractive index of the dielectric film layer 18 due to the electric field applied between the backplane electrode layer 16 and the upper electrode film layer 24 by the AC signal 30. The photorefraction characteristics may be used for promoting propagation of the light which permeates the superposed layers constituting the EL device. An example of the material having such photorefraction characteristics is BaTiO₃.

### (Phosphor Film Layer)

The phosphor film layer 20 may be formed by distributing an electrically half-conductive fluorescence material of a representative metal doped zinc sulfide (ZnS) etc. in a polymer matrix through which an electric charge (electron) accelerated by an electric field can penetrate. The fluorescence material has a function to absorb energy from the electrostatic field alternatingly generated by the AC signal 28 when excited by the electrostatic field and then re-release the energy as a photon of visible light when relaxed by the ground state. Furthermore, the fluorescence material forms the additional insulation barrier between the backplane electrode layer 16 and the upper electrode film layer 24 as well as the layer of the bus bar 26 by being distributed and enclosed in the polymer matrix having electrical insulation properties.

The polymer matrix used for the phosphor film layer 20 may be a material used for well-known inorganic EL, an example of which may be acrylic polymer. The fluorescence material used for the phosphor film layer 20 may be an aluminum sulfide based phosphor material such as Barium thioaluminate (BaAl₂S₄), a zinc sulfide (ZnS) based fluorescence material or an alkaline-earth-metals sulfide fluorescence material such as strontium sulfide (SrS), etc., but not limited to these materials. Furthermore, luminescence of various colors may be possible by adding a small quantity of transition metal ion or a rare-earth metal ion to a mother material such as BaAl₂S₄, ZnS or SrS. For example, ZnS:Mn emits orange color light, ZnS:Tb emits green color light, SrS:Ce emit blue-green color light, CaS:Eu emits red color light and BaAl₂S₄:Eu emits blue color light blue. In addition thereto, the fluorescence material may have a characteristic of quantum dot.

### (Upper Electrode Film Layer)

The upper electrode film layer 24 is electrically conductive and totally transparent. The upper electrode film layer 22 may be made of a material such as an electrically conductive polymer (PEDOT), a carbon nanotube (CNT), an antimony tin oxide (ATO) and an indium tin oxide (ITO). The desirable material is CLEVIOS (trademark) of Heraeus Clevios GmbH, an electrically conductive, transparent and flexible polymer, which is diluted with isopropyl alcohol. This is comparatively harmless to environment.

An indium tin oxide (ITO) and an antimony tin oxide (ATO) may be used as other materials of the upper electrode film layer 22, but CLEVIOS (trademark) is desirable in consideration of an environmental problem.

As already stated, the backplane electrode layer 16 may be totally transparent, but in this case, either of the materials used for the upper electrode film layer 22 may be the material of the backplane electrode layer 16.

### (Bus Bar)

The bus bar 26 functions as a connection area for suppling the AC signal between the backplane electrode layer 16 and the upper electrode film layer 24. The bus bar 26 may comprise a small piece of comparatively lower impedance formed of one or more materials usually used for forming the backplane electrode layer 16. Generally, the bus bar 26 may be applied to the peripheral edges of the lighting areas of the EL device. In the illustrated embodiment, although the bus bar 26 is provided adjacent to the upper electrode film layer 24, the bus bar 26 may be provided in either of the upper electrode film layer 24 and the backplane electrode layer 16 or only in the backplane electrode layer 16.

In FIG. 1, the bus bar 26 may be formed so as to be adjacent to the upper electrode film layer 22, but it may be provided on the top part of the upper electrode film layer and conversely provided on the bottom of the upper electrode film layer 22.

### (Topcoat Layer)

The topcoat layer 28 may be coated on the upper electrode film layer 24 and the bus bar 26 as well as the peripheral edge of the primer layer 14 in order to protect the EL device from damage after hardening of the coat film of the upper electrode film layer 24 and the bus bar 26 and the topcoat layer 28 may be formed of a transparent and electrical insulation material such as a transparent polymer of moderate hardness for enclosing the EL device 10. In order to reduce the degradation of the transparent electrode film layer 24 due to the humidity, the primer layer 28 may be desirably formed of a material excellent in damp-proofing.

### (Decorative Pattern Layer)

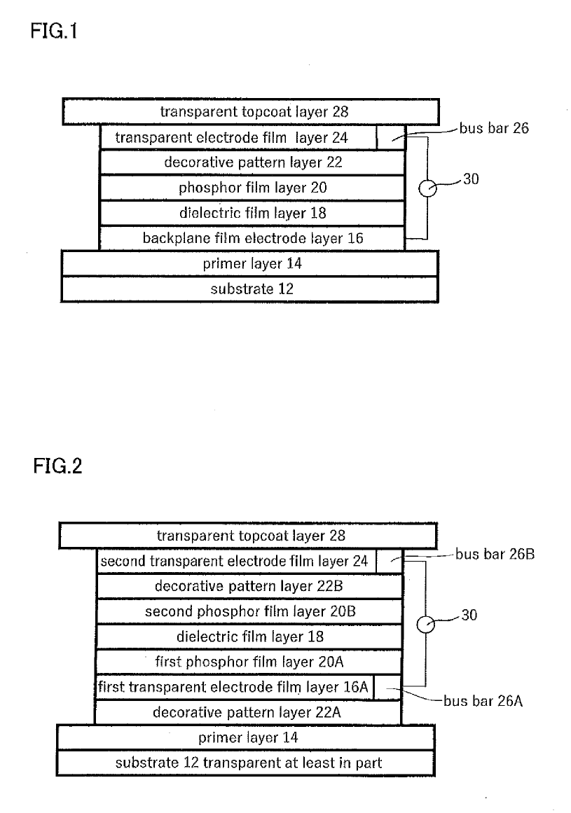

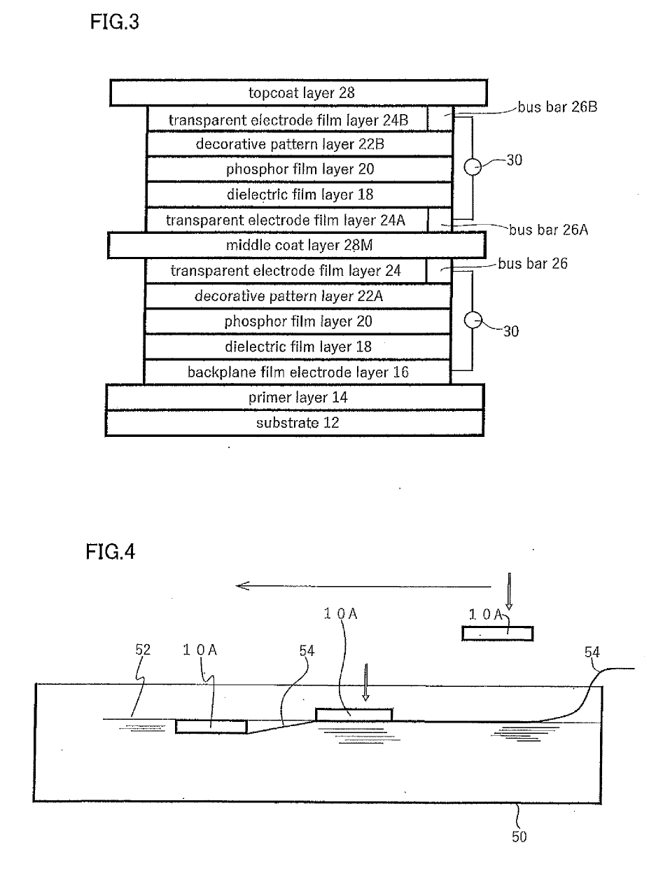

As explained in detail with reference to FIG. 5 later, the decorative pattern layer 22 is formed by transferring under water pressure on the surface of the phosphor film layer 20, a predetermined pattern of a transfer film 54 comprising a water-soluble film on which the pattern is printed. The reason for forming the decorative pattern layer 22 on the upper side (pattern viewing side) of the phosphor film layer 20, but not the bottom side (pattern not viewing side) of the phosphor film layer 20 is that the phosphor film layer 20 has a low light transmittance state in its thickness direction whereby the pattern is invisible through the topcoat layer 28. However, as shown in other forms of embodiments illustrated in FIGS. 2 and 3, which will be explained later, in case where the pattern should be viewed on the side of substrate 12, the decorative pattern layer 22 should be formed on the bottom side (viewing side) of the phosphor film layer 20.

### (Spray Coating)

As already stated, in the EL device 10, the primer layer 14, the bus bar 28 and the topcoat layer 26 as well as the backplane electrode layer 16, the dielectric film layer 18, the phosphor film layer 20 and the upper electrode film layer 24 may be also “painted” on the substrate 12 by spray coating. This coating technology may be applicable to various materials and/or complicated surface form. The dielectric film layer 18, the phosphor film layer 20, the primer layer 14 and the topcoat layer 26 can provide a conformal EL device by using a material excellent in electrical insulation properties and providing damp-proofing to the topcoat layer 26, if needed.

### (Explanation of Each Step)

The manufacturing steps of the EL device of FIG. 1 will be explained in detail below.

### (Step of Selecting the Substrate)

This step corresponds to the step (A) in the form of first embodiment of the invention, as already explained, the substrate 12 may be a surface of appropriate article, which may be either of electrically conductive or nonconductive material and may have arbitrary outlines and shapes.

### (Step of Coating the Primer Layer)

The primer layer 14 may be coated on the substrate 12 to electrically insulate the substrate 12 and the EL devices 10 and may desirably adhere to the topcoat layer 28 in a positive manner so that the lamination of the EL device 10 may be enclosed together with the topcoat layer 28. In addition thereto, in order to promote the adhesion of the enclosing topcoat layer 28 to the primer layer 14, a thin layer of enamel/lacquer/aqueus paint may be coated on the primer layer 14.

### (Step of Electrical Connection)

An electric connection is carried out in order to provide signal courses to supply the AC signal 30 for exciting the phosphor film layer 20 for every “lighting domain” of the EL device. These signal courses may be formed using carry-through technology as an example. For example, in case where the substrate 12 is of electrically non-conductive material such as plastics, glass fibers or the composite thereof, at least one “carry-through” electrically conductive element will be provided in the backplane electrode layer 16 and the bus bar 26 so as to extend through a small opening provided in the substrate 12 and the primer layer 14 to electrically connect the backplane electrode layer 16 and the bus bar 26 to each other. In case where the substrate 12 is of electrically conductive material, there is provided a cover for electrically insulating the substrate 12 and the carry-through from each other. The detailed step of the electrical connection of the backplane electrode layer 16 and bus bar 26 by such carry-through technology is as illustrated in FIG. 3 of the Patent Document Nos. 1 through 3 and described in the explanation relevant to FIG. 3.

In case where the use of the aforementioned carry-through technology to the substrate 12 is practically forbidden on its structure, the signal course through the EL device 10 may be formed of an electric conduction element embedded in the insulating primer layer 14. Otherwise, it may be formed by wiring along the surface of the panel edge.

### (Step of Coating the Backplane Electrode Layer)

The backplane electrode layer 16 is a pattern containing an electric conduction material and is formed by being laminated on the surface of the primer layer 14. The backplane electrode layer 16 may be preferably coated to a thickness of about 0.001 inch (0.0254 mm), for example, by using an airbrush or a gravity supply type spraying apparatus having a sufficiently fine hole. If the backplane electrode layer 16 may be coated in this way, it will be arranged so a to contact the electric conduction element to thereby electrically contact the AC signal 30 and a general outline will be formed in the domain of the turned-on EL device 10.

### (Step of Coating the Dielectric Film Layer)

The dielectric film layer 18 may be formed by coating an electrically non-conductive solution containing BaTiO₃ by using a suction and/or pressure supply type spray apparatus.

### (Step of Coating the Phosphor Film Layer)

The phosphor film layer 20 may be formed by coating a phosphor solution of oversaturation filled with a fluorescence material such as a metal doped zinc sulfide (ZnS) using a suction type and/or pressure supply type spray apparatus under a predetermined air pressure adjusted to the variable such as ambient temperature or a shape of the substrate 12. The phosphor film layer 20 may be desirably applied while the fluorescence material emits light under an ultraviolet ray irradiation light source in order to view the coated domain.

### (Step of Hardening the Dielectric Film Layer and the Phosphor Film Layer)

As the dielectric film layer 18 and the phosphor film layer 20 both of which have a desired thickness and the distribution are coated and deposited and the time elapses enough to evaporate and remove the remaining moisture from the dielectric film layer 18 and the phosphor film layer 20, the deposit will be hardened and the dielectric film layer 18, the phosphor film layer 20 and the backplane electrode layers 16 are mechanically bonded to each other. This time will change according to the environmental factor such as temperature or humidity. The hardening step may be appropriately accelerated by using an infrared heat source.

### (Step of Adhesion of the Decorative Pattern Layer)

Thereafter, the decorative pattern layer 22 having an appropriate pattern is applied onto the surface of the phosphor film layer 20 by a water pressure transfer method. Although the water pressure transfer method is well-known technology, the outline of the method will be explained with reference to FIG. 4. As illustrated in FIG. 4, after forming the stack (article 10A with the laminate) having the phosphor film layer 20 of the EL device 10 finally laminated, a transfer film 52 comprising a water-soluble film having a predetermined pattern or decorative pattern (decorative pattern as simply referred to as later) printed in a negative state and activated (adhesion imparted) is floated on a water surface 52 in a water tank 50 and the stack (article 10A with the laminate) having the layers from the substrate 12 to the phosphor film layer 20 stacked is forced under water with the phosphor film layer 20 faced toward the transfer film 52. Using the thus generated water pressure, the decorative pattern of the transfer film 52 is transferred to the phosphor film layer 20 whereby the decorative pattern is adhered on the phosphor film layer 20 in a positive state. Although the water-soluble film dissolves with the water in the water tank 50 after transfer of the decorative pattern, the remaining water failing to be dissolved by the water in the water tank 50 is compulsorily removed by a shower after pulling up the article from the tank 50. Thereafter, the article 10A is dried by a hot wind etc. whereby the decorative pattern layer 22 is formed from the decorative pattern physically bonded to the phosphor film layer 20. The step of adhesion of the decorative pattern layer (water pressure transfer step) may be carried out by any of a batch system (a system in which the transfer is carried out for every article 10A with the stack deposited) or a continuation system (a system in which many articles 10 with stack are sequentially conveyed into the water tank and the pattern is continuously transferred onto the articles). When carrying out the water pressure transfer of the decorative pattern layer 22, if a foreign substance lies on the surface of the phosphor film layer 20, there will be carried out a surface treatment such as polish for removing the foreign substance, which is conventionally carried out in a general water pressure transfer. In this case, the phosphor film layer 20 is never damaged by the polish and may be correctable with a re-spray coating even if the phosphor may be subject to a damage by the polish.

### (Step of Coating the Bus Bar)

The bus bar 26 may be usually coated on the stack having the decorative pattern layer 22 applied using an airbrush or a gravity supply type spray apparatus having a sufficiently fine hole provided therein. The bus bar 26 supplies a current to the upper side transparent electrode film layer 24, forms an electric conduction course along the periphery of the predetermined EL lighting domain so as to electrically contact the transparent electrode film layer 24 and forms the outer edge in the EL lighting domain of predetermined pattern.

### (Step of Coating the Upper Electrode Film Layer)

The upper transparent electrode film layer 24 is formed by spray coating on the decorative pattern layer 22 using an airbrush or a gravity supply spray apparatus having a sufficiently fine hole. At this time, the upper electrode film layer 24 forms an electric conduction path between the bus bars 26 in the circumference portion of the EL domain. The upper electrode film layer 24 may desirably apply the electric signal 30 between the upper electrode film layer 24 and the backplane electrode layer 16 in order to visually monitor the irradiation of the phosphor film layer 20 during the coating.

### (Step of Coating the Topcoat Layer)

The topcoat layer 28 may be also coated on the transparent electrode film layer 24 and the primer layer 14 by spray coating using a proper spray apparatus so that the topcoat layer 28 may enclose the EL layers under the topcoat layer 24. Therefore, the stack-up of the EL device 10 is completely covered by the substrate 12 and the topcoat layer 28 and the EL device is protected from its damage.

### (Coating of a Protection Layer)

Although not illustrated, in order to operate an apparent color emitted by the EL device 10, the EL device 10 may have the topcoat layer 28 colored with pigment or a pigment-colored protective film applied on the topcoat layer 28 so that a light transmittance state may be imparted to the topcoat layer 28 of the EL device 10. The apparent color may be corrected or changed if a colored phosphor is alternatively included in the colored protective film.

### Second Form of Embodiment

A second form of embodiment of the present invention is shown in FIG. 2. In this form of embodiment, the EL layer by which the EL device 10 is formed has a double structure, within which at least one decorative pattern layer may be provided. Described in more detail, the following steps (A) through (F) are included in this form of embodiment.

(A) the step of selecting a substrate 12 having a visual transparent area formed at least in part;
(B) the step of coating a first electrode film layer (backplane electrode layer) 16A of transparent and electrically conductive material on the substrate 12;
(C1) the step of coating a first phosphor film layer 20A on the first electrode film layer 16A;
(D) the step of coating a dielectric film layer 18 on the first phosphor film layer 20A;
(C2) the step of coating a second phosphor film layer 20B on the dielectric film layer 18;
(E) the step pf coating a second transparent electrode film electrode layer 24 on the second phosphor film layer 20B;
(F) the step of forming a decorative pattern layer 22 at least in part on an interlayer of one or both of the following interlayers (a) and (b);
(a) an interlayer between the substance 12 selected in the step (A) and the first transparent electrode film layer 16A formed by the step (B)
(b) an interlayer between the second phosphor film layer 20B formed by the step (C2) and the second electrode film layer 24 formed by the step (E);
wherein in the aforementioned steps (B) through (E), the transparent backplane electrode layer 16, the dielectric film layer 18, the first and second phosphor film layers 20A and 20B and the transparent electrode film layer 24 are formed by spray coating, respectively and the decorative pattern layer 22 is formed by a water pressure transfer method in the step (F).

In the second form of embodiment, the material of each of layers and the coating process in the illustrated example are the same as the first form of embodiment, but in the illustrated form, two decorative pattern layers 22A and 22B may be formed on the interlayers of both of (a) and (b). Of course, any one of the decorative pattern layers 22A and 22B may be selected. In the same manner as in the first form of embodiment, the primer layer 14 may be formed between the substrate 12 and the first decorative pattern layer 22A and the topcoat layer 28 may be formed on the second transparent electrode film layer 24. Furthermore, bus bars 26A and 26B may be coated adjacent to the first transparent electrode film layer (backplane layer) 16A and the transparent electrode film layer 24, respectively. The AC signal 30 may be applied through the same signal wire as that of the first form of embodiment between the bus bars 26A and 26B whereby an AC magnetic field may be generated between the first and second transparent electrode film layer 16 and 24. The primer layer 14 in this form of embodiment form may be desirably transparent.

### Modification of the Invention

FIG. 3 illustrates a device substantially identical to that of the first form of embodiment except for two EL device components provided in the upper and lower sides through a middle coat layer 28M of electrical insulation. Describing it in more detail, on the first EL component having the structure of FIG. 1 are laminated a transparent electrode film layer 24A, a dielectric film layer 18, a phosphor film layer 20 and a transparent electrode film layer 24B to thereby form the second EL component. The middle coat layer 28M forms the layer corresponding to the topcoat layer of the first EL component. In case where the optical semi-translucent characteristics relative to the light of visible wavelength in the upper and lower EL components are different from each other, one of the components may be selectively excited or both of the components may be excited whereby the apparent color can be substantially corrected. In the present modification, the middle coat layer 28M may be desirably transparent and the dielectric film layer 18, the phosphor film layer 20 and the decorative pattern layer 22 of the EL device component on the side of the topcoat layer 28 may be a pattern which can view the decorative pattern layer 22 of the EL device component on the side of the substrate and the EL luminescence therefrom.

### Operation of the EL Device of the Invention

(Part 1)

Describing the operation of the EL device 10 of the present invention in detail with respect to the representative form of the embodiment shown in FIG. 1, when the AC signal 30 is applied between the backplane film electrode layer 16 and the bus bar 26 through the carrier-through (electrically conductive element), the AC signal is sent to the electrode layer 16 and the transparent electrode film layer 24, respectively to thereby generate the AC electric field in the phosphor film layer 20 between them. The electric field generates an electric charge at the border face of the dielectric film layer 18 and the phosphor film layer 20 and the electric charge is accelerated and emitted by means of the electric field within in the phosphor film layer 20 whereby the fluorescence material in the phosphor film layer 20 is excited and when relaxed by the ground state, the phosphor film layer 20 emits the light. The light emitted by the phosphor film layer 20 passes the enclosing transparent topcoat layer 26 through the decorative pattern layer 22 and can be viewed as a luminescent design together with the pattern of the decorative pattern layer 22.

(Part 2)

In the embodiment form of FIG. 2, the first phosphor film layer 20A and the second phosphor film layer 20B emit a light according to the same principle as the luminescence principle of the embodiment form of FIG. 1. The light emitted from the first phosphor film layer 20A penetrates the transparent substrate 12 transparent at least portion thereof while the light emitted from the second phosphor film layer 20B penetrates the transparent topcoat layer 28 and the light from the first and second phosphor film layers 20A and 20B can be viewed as respective luminescent design from both of the lower and upper sides of the EL device together with the pattern of the decorative pattern layers 22A and 22B provided on the lower side of the phosphor film layer 20A and the upper side of the phosphor film layer 20B, respectively.

(Part 3)

In the embodiment form of FIG. 3, the phosphor film layer 20 of each of the EL device component emits a light according to the same principle as the luminescence principle of the embodiment form of FIG. 1 and the light passes the topcoat layer 28 through the respective decorative pattern layer 22 laminated on the respective phosphor film layer 20. The dielectric film layer 18, the phosphor film layer 20 and the decorative pattern layer 22B of the EL device component on the side of the topcoat layer 28 may have the pattern through which can be viewed the phosphor film layer 20 and the decorative pattern layer 22A of the EL device component on the side of the substrate whereby each of the decorative pattern layers 22A and 22B can be viewed as a luminescent design accompanied by the pattern in the form of deployment or superposition. What is meant by “deployment” is that the patterns of the first and second decorative pattern layers 22A and 22B appear in line with each other on a plane without being superposed with each other because the first and second decorative pattern layers 22A and 22B can be viewed so that the pattern of the first decorative layer 22A on the back side as viewed from the transparent topcoat layer 28 is viewed from the front face of the transparent topcoat layer 28 through the pattern removed portion of the second decorative layer 22B. What is meant by “superposition” is that the patterns of the first and second decorative pattern layers 22A and 22B appear so as to be sterically superposed with each other. In any case, since the patterns of the first and second decorative pattern layers 22A and 22B are disposed far away in the thickness direction of the EL device, there appears the luminescent design having a feeling of depth.

### INDUSTRIAL AVAILABILITY

According to the invention, since each layer of the EL device is formed by spray coating, it can be easily formed on the substrate having complicated surface, but the decorative pattern layer is formed within the EL layer by water pressure transfer and therefore there is provided the EL device with the curved surface having excellent workability and mass production wherein the decorative pattern layer can be formed without any damage of the EL device and a stable design can be obtained due to a combination of the pattern and the EL luminescence, which provides a high industrial availability.

### EXPLANATION OF NUMERALS

10 EL device
10A Article with stacks
12 Substrate (Surface of article)
14 Primer Layer
16, 16A Backplane electrode layers
18, 18A and 18B Dielectric film layers
20, 20A and 20B Phosphor film layers
22, 22A and 22B Decorative pattern layer
24 Transparent Electrode Film Layer
26, 26A and 26B Bus bar
28 Topcoat Layer
28M Middle coat layer
30 AC Signal
50 Water tank
52 Water Surface
54 Transfer Film

1. A method of manufacturing an electroluminescence device, said method comprising the following steps of:
(A) selecting a substrate;
(B) applying a base backplane film layer upon said substrate;
(C) applying a dielectric film layer upon said backplane film layer;
(D) applying a phosphor film layer upon said dielectric film layer; and
(E) applying a transparent electrode film layer upon said phosphor film layer, wherein said backplane film layer, said dielectric film layer, said phosphor film layer and said transparent electrode film layer each are applied by spray coating;
said method characterized by further comprising the step of (F) forming a decorative pattern layer by water pressure transfer method on at least one portion between said phosphor layer formed by the step (D) and said electric film layer formed by the step (E).

2. A method of manufacturing an electroluminescence device, comprising the following steps of:
(A) selecting a substrate, at least one portion of which is visually transparent;
(B) applying a first electrode film layer of transparent and electrically conductive material upon said substrate;
(C1) applying a first phosphor film layer upon said first electrode film layer;
(D) applying a dielectric film layer upon said first phosphor layer; and
(C2) applying a second phosphor film layer upon said dielectric film layer; and
(E) applying a second electrode film layer upon said second phosphor film layer;
wherein said first electrode film layer, said first phosphor film layer, said dielectric film layer, said second phosphor film layer and said second electrode film layer each are formed by spray coating,
said method characterized by further comprising the step of (F) forming a decorative pattern layer by water pressure transfer method on at least one portion between said substrate selected by the step (A) and said first electrode film layer formed by the step (B) and/or between said second phosphor film layer formed by the step (C2) and said second electrode film layer formed by the step (E).

3. A method of manufacturing an electroluminescence device as set forth in claim 1 and further comprising two or more electroluminescence device components each formed using the steps of claim 1.

4. An electroluminescence device formed by the steps of claim 1.

5. An electroluminescence device according to claim 4, further comprising two or more electroluminescence device components each formed using the steps of claim 1.

6. An electroluminescence device formed by the steps of claim 2.
